(19) United States
(12) Patent Application Publication
(10) Pub. No.: US 2019/0391333 A1
(43) Pub. Date: Dec. 26, 2019

(54) OPTICAL COUPLING DEVICE

(71) Applicant: TDK Corporation, Chuo-ku, Tokyo (JP)

(72) Inventors: Motohiro NAKAHARA, Mito-shi, Ibaraki (JP); Tetsuo MIYA, Mito-shi, Ibaraki (JP)

(21) Appl. No.: 16/480,852

(22) PCT Filed: Jan. 12, 2018
(86) PCT No.: PCT/JP2018/000624

§ 371 Date: Jul. 25, 2019

(30) Foreign Application Priority Data
Jan. 25, 2017 (JP) 2017-011269

(51) Int. Cl. G02B 6/26; G02B 6/44; G02B 6/255

(52) U.S. Cl. CPC G02B 6/262; G02B 6/255; G02B 6/4401

(57) ABSTRACT

An optical coupling device that exhibits high air tightness between a capillary and an optical fiber formed of the same glass material. An optical coupling device according to this disclosure includes: an optical fiber having an end portion being a bare fiber where a part of coating has been removed, metal plating being applied to the bare fiber around an end portion of the remaining coating and a circumference of the coating; a capillary having a through-hole having one end where the end portion of the bare fiber is positioned and the other end where the end portion of the coating of the optical fiber subjected to the metal plating is placed, metal plating being applied to an inner wall surface of the other end of the through-hole; and solder that seals a gap between the optical fiber 11 placed in the other end of the through-hole and an inner wall of the through-hole.

### BACKGROUND

### 1. Field of the Disclosure

This disclosure relates to an optical coupling device for connecting an optical fiber to an optical circuit.

### 2. Discussion of the Background Art

An optical coupling device for connecting an optical fiber and an optical component has been proposed (for example, see Patent Literature 1). In the optical coupling device of Patent Literature 1, a tongue-piece slit having a minimum width necessary for leading an optical fiber out is placed inside a casing, a gap between the casing and the tongue-piece slit is filled with a sealing material, and the sealing material is softened, such that an opening of the casing of the optical component is sealed with a small amount of a sealing material.

The optical coupling device of Patent Literature 1 uses a resin-based adhesive such as an epoxy-based adhesive as a sealing material. In addition, in the optical coupling device of Patent Literature 1, the optical fiber is directly fixed.

### CITATION LIST

### Patent Literature

Patent Literature 1: JP 2016-145931 A

### SUMMARY

### Technical Problem

As optical components are miniaturized and their performances improve, air tightness higher than that of the resin-based adhesive is demanded. In addition, if the optical fiber is directly fixed to the casing, the optical fiber may be broken at the time of handling of the optical component.

In this regard, an object of this disclosure is to provide an optical coupling device for connecting an optical fiber and an optical component, capable of improving air tightness and preventing breakage of the optical fiber.

### Solution to Problem

According to this disclosure, there is provided an optical coupling device including: an optical fiber having an end portion being a bare fiber where a part of coating has been removed, metal plating being applied to the bare fiber around an end portion of the remaining coating and a circumference of the coating; a capillary having a through-hole having one end where the end portion of the bare fiber is positioned and the other end where the end portion of the coating of the optical fiber with the metal plating is placed, metal plating being applied to an inner wall surface of the other end of the through-hole; and solder that seals a gap between the optical fiber placed in the other end of the through-hole and an inner wall of the through-hole.

According to this disclosure, there is provided an optical coupling device including: an optical fiber having an end portion being a bare fiber where a part of coating has been removed; a capillary having a through-hole having one end where the end portion of the bare fiber is positioned and the other end where an end portion of the remaining coating of the optical fiber is placed; and low melting-point glass that seals a gap between the bare fiber placed inside the through-hole and an inner wall of the through-hole, the low melting-point glass having a melting point lower than those of the bare fiber and the capillary.

In the optical coupling device according to this disclosure, the other end of the through-hole of the capillary may be tapered.

In the optical coupling device according to this disclosure, the end portion of the bare fiber is positioned in the one end of the through-hole with a gap narrower than that of the other end of the through-hole.

In the optical coupling device according to this disclosure, the optical fiber may have a first optical fiber and a second optical fiber, the second optical fiber having a core having a numerical aperture larger than that of the first optical fiber and having one end fusion-bonded to the first optical fiber, fusion bonded portions of the first and second optical fibers may be placed inside the through-hole, an end portion of the second optical fiber may be positioned in the one end of the through-hole with a gap narrower than that of the other end of the through-hole, and the fusion bonded portion of the through-hole may have an inner diameter larger than that of a vicinity of the other end portion of the second optical fiber.

In the optical coupling device according to this disclosure, metal plating may be applied to a side face of the capillary.

Note that each of the aforementioned aspects of the disclosure may be combined as long as possible.

### Advantageous Effects of Invention

According to this disclosure, it is possible to provide an optical coupling device for connecting an optical fiber and an optical component, capable of improving air tightness and preventing breakage of the optical fiber.

### BRIEF DESCRIPTION OF THE DRAWINGS

FIG. 1 illustrates exemplary mounting of an optical coupling device according to a first embodiment of this disclosure to a casing.

FIG. 2 is an enlarged view illustrating an exemplary optical coupling device according to the first embodiment of this disclosure.

FIG. 3 is a cross-sectional view illustrating the exemplary optical coupling device according to the first embodiment of this disclosure.

FIG. 4 illustrates exemplary mounting of an optical coupling device according to a second embodiment of this disclosure to a casing.

FIG. 5 is an enlarged view illustrating an exemplary optical coupling device according to the second embodiment of this disclosure.

FIG. 6 is a cross-sectional view illustrating the exemplary optical coupling device according to the second embodiment of this disclosure.

FIG. 7 is an enlarged view illustrating an exemplary optical coupling device according to a third embodiment of this disclosure.

FIG. 8 is an enlarged view illustrating another exemplary optical coupling device according to the third embodiment of this disclosure.

### DETAILED DESCRIPTION OF THE PREFERRED EMBODIMENT

Embodiments of this disclosure will be described in details with reference to the accompanying drawings. Note that this disclosure is not limited to the following embodiments. Such embodiments are merely for exemplary purposes, and this disclosure may be embodied in various changed or modified forms on the basis of understandings of those ordinarily skilled in the art. Note that like reference numerals denote like elements throughout the descriptions and the drawings herein.

### First Embodiment

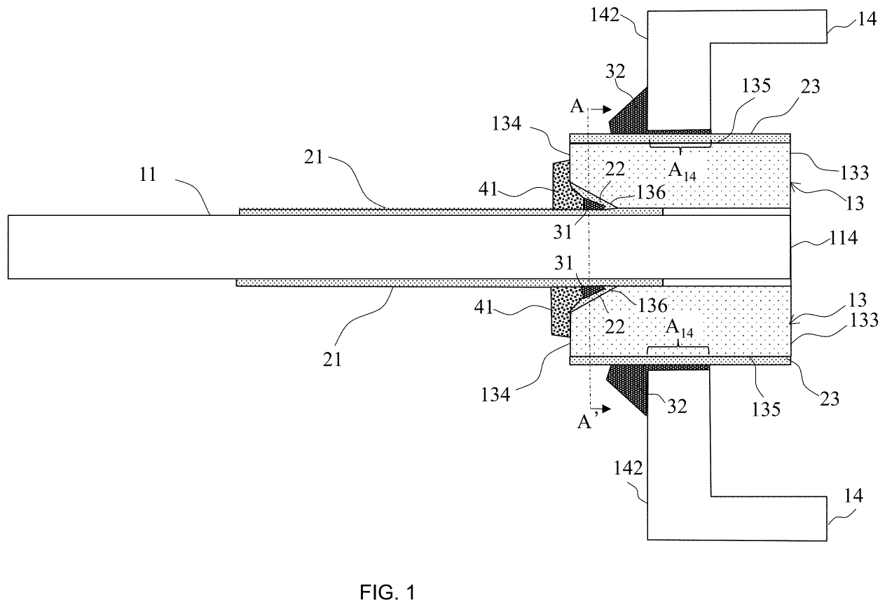

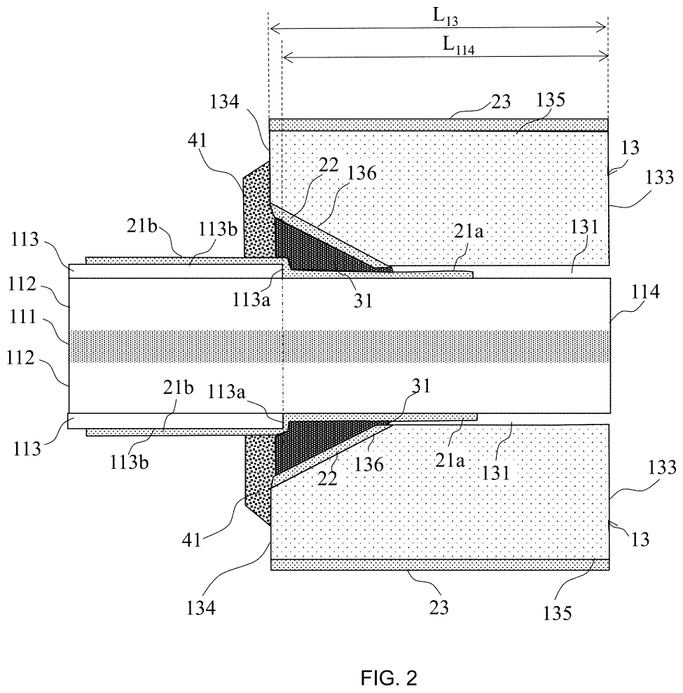

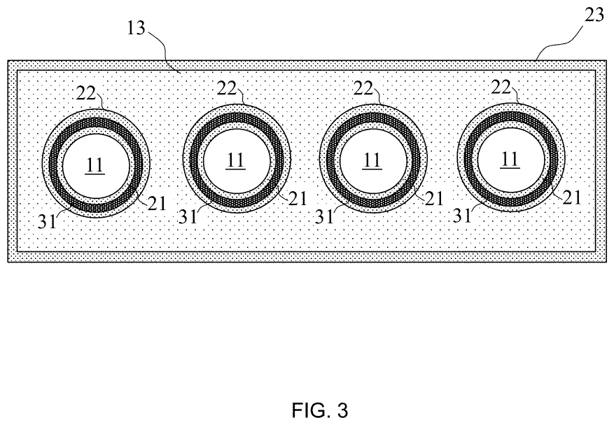

FIG. 1 illustrates exemplary mounting of an optical coupling device according to this embodiment to a casing. FIG. 2 is an enlarged view illustrating an optical coupling device according to this embodiment. FIG. 3 illustrates a cross-sectional view taken along the line A-A′ of FIG. 1. The optical coupling device according to this embodiment has an optical fiber 11 and a capillary 13. According to this embodiment, the optical coupling device is an optical fiber array in which a plurality of optical fibers 11 are arranged as illustrated in FIG. 3 by way of example.

In order to improve air tightness, it is preferable to seal a gap between the optical fiber 11 and the capillary 13 with solder 31. However, since the optical fiber 11 and the capillary 13 are formed of a glass material, a gap may be generated between the solder 31 and the optical fiber 11 or the capillary 13. In this regard, in the optical coupling device according to this embodiment, a gap between the solder 31 and the optical fiber 11 or the capillary 13 is prevented by applying metal plating to the optical fiber 11 and the capillary 13.

An end portion of the optical fiber 11 is a bare fiber where coating 113 has been removed. The capillary 13 has a through-hole for placing the optical fiber 11. The entire bare fiber of the optical fiber 11 is placed in the through-hole. As a result, the optical coupling device according to this embodiment is capable of preventing breakage of the optical fiber 11.

An end face 114 of the bare fiber as an end portion of the optical fiber 11 is placed in one end arranged in an end face 133 side of the through-hole. In the through-hole, the end face 133 side is narrower than the end face 134 side, and a location of the end face 114 of the optical fiber 11 is positioned in a location of the through-hole inside the end face 133. The end face 114 of the bare fiber is connected to an optical circuit which is not illustrated. It is preferable that the end face 114 of the bare fiber has been subjected to 8° polishing or anti-reflection coating in order to avoid reflection on the end face 114. In addition, the optical circuit connected to the end face 114 of the bare fiber may include an isolator, a laser diode (LD) chip, or the like.

Metal plating 21 is applied on a circumference of the optical fiber 11 in a part arranged in the end face 134 side of the through-hole. Metal plating 22 is applied on an inner wall surface 136 of the end face 134 side of the through-hole. As illustrated in FIG. 3, a gap between the metal plating 21 applied to the optical fiber 11 and the metal plating 22 applied to the inner wall surface 136 is sealed with the solder 31.

An end portion 113a of the coating 113 is preferably placed inside the through-hole of the capillary 13. For example, a length L₁₁₄ from the end portion 113a of the coating portion to the end face 114 of the bare fiber is shorter than a length L₁₃ of the through-hole of the capillary 13. In this case, it is preferable to apply the metal plating 21 to the bare fiber around the end portion 113a of the coating 113 and the circumference of the coating 113.

In a case where the coating 113 subjected to the metal plating 21 is placed inside the through-hole of the capillary 13, the end face 134 side of the through-hole is preferably tapered. As a result, it is possible to easily place the optical fiber 11 inside the through-hole. In this case, the metal plating 22 is preferably applied to the tapered inner wall surface 136. As a result, when the solder 31 is formed between the coating 113 of the optical fiber 11 and the inner wall surface 136, the solder 31 is retained on the tapered inner wall surface 136, so that it is possible to easily form the solder 31 in the gap between the metal plating 21b of the coating 113 and the metal plating 22 of the capillary 13 and to eliminate a gap 131 between the optical fiber 11 and the inner wall surface 136.

Metal plating 23 is applied to a side face 135 of the capillary 13. In order to improve air tightness when the optical coupling device is assembled to the casing 14, a gap between the side face 135 of the capillary 13 and the casing 14 is preferably sealed with solder 32. In this case, since the metal plating 23 is applied to the side face 135 of the capillary 13, it is possible to seal a gap between the capillary 13 and the casing 14 with high air tightness.

The metal plating 23 is provided in a region A₁₄ fixed to the casing 14. By filling a gap between the casing 14 and the metal plating 23 with the solder 32, it is possible to seal the gap between the casing 14 and the capillary 13. The metal plating 23 is preferably applied to a range wider than the region A₁₄. As a result, it is possible to prevent peeling of the metal plating 23 caused by the solder 32. For example, the metal plating 23 is preferably provided over the entire outer periphery of the capillary 13.

The end portion of the end face 134 side of the through-hole is preferably filled with an adhesive 41. The adhesive 41 is placed to cover the circumference of the coating 113. As a result, a ratio of the stress of the adhesive 41 directly applied to the optical fiber 11 is reduced, a polarization extinction ratio is improved, and it is possible to prevent breakage of the optical fiber 11.

The metal plating used in the metal plating 21, 22, and 23 may include gold plating, Au/Sn plating, or Cu plating. In addition, when the metal plating 21, 22, and 23 are applied, they may be applied to the bare fiber, the circumference 113b of the coating, the inner wall 136 of the through-hole, and the side face 135 of the capillary by ion plating, electroless plating, sputtering, or the like. If gold plating, Au/Sn plating, or Cu plating is employed as the metal plating of the metal plating 21, 22, and 23, the solder used in the solder 31 and 32 is preferably Au/Sn-based solder having high affinity.

A method of producing the optical coupling device according to this embodiment includes a metal plating process, an assembling process, a soldering process, a polishing process, and a bonding process in this order.

In the metal plating process, plating is applied to the bare fiber around the end portion 113a of the coating 113, the circumference of the coating 113, and the inner wall surface 136 of the capillary 13. As the plating method, ion plating, electroless plating, or sputtering, for example, may be used.

In the assembling process, the optical fiber 11 is inserted into an opening of the end face 134 side out of two openings of the through-hole of the capillary 13 such that the end portion 113a of the coating 113 is placed inside the through-hole of the capillary 13. Here, the fiber 11 can be positioned by narrowing the gap 131 between an outer diameter of the fiber 11 (including the metal plating 21) where the coating has been removed and the hole of the capillary.

In the soldering process, a gap between the optical fiber 11 and the inner wall of the through-hole of the capillary 13 is sealed with solder.

In the polishing process, the end face 114 of the bare fiber is polished after the length of the end face 114 of the bare fiber is aligned with the position of the end face 133 of the capillary 13. In this case, it is preferable to apply 8° polishing or anti-reflection coating to the end face 114.

In the bonding process, the capillary 13 and the optical fiber 11 are fixed using an adhesive. For example, ultraviolet curable resin is injected into the circumferences of the optical fiber 11, the capillary 13, and the solder 31 from the end face 134 side, and ultraviolet rays are emitted from the end face 134 side of the capillary 13. As a result, it is possible to bury the gap between the optical fiber 11 and the capillary 13 and improve air tightness of the optical coupling device.

As described above, in the optical coupling device according to this embodiment, the metal plating 21 is applied to the optical fiber 11 and the capillary 13, and a gap between them is sealed with the solder 31, so that it is possible to improve air tightness of the optical coupling device. In addition, in the optical coupling device according to this embodiment, since the end portion of the optical fiber 11 is protected by the capillary 13, it is possible to prevent breakage of the optical fiber 11. Therefore, the optical coupling device according to this embodiment is an optical coupling device for connecting the optical fiber 11 and the optical component, capable of improving air tightness and preventing breakage of the optical fiber.

Although an optical fiber array in which four optical fibers 11 are arranged along a straight line has been described in this embodiment as an example of the optical coupling device, the optical coupling device according to this disclosure is not limited thereto. For example, the optical coupling device according to this disclosure may have any number of optical fibers 11 such as one, 16, or 32. In addition, the optical coupling device according to this disclosure may be an optical fiber array in which the optical fibers 11 are arranged two-dimensionally.

Note that the optical fiber 11 may be formed of a plastic material. In this case, in the metal plating process, plating is applied by ion plating, electroless plating, or sputtering. In addition, a melting point of the solder used in the soldering process is set to be low so as not to affect the plastic. Examples of applicable solder may include eutectic solder (leaded solder).

### Second Embodiment

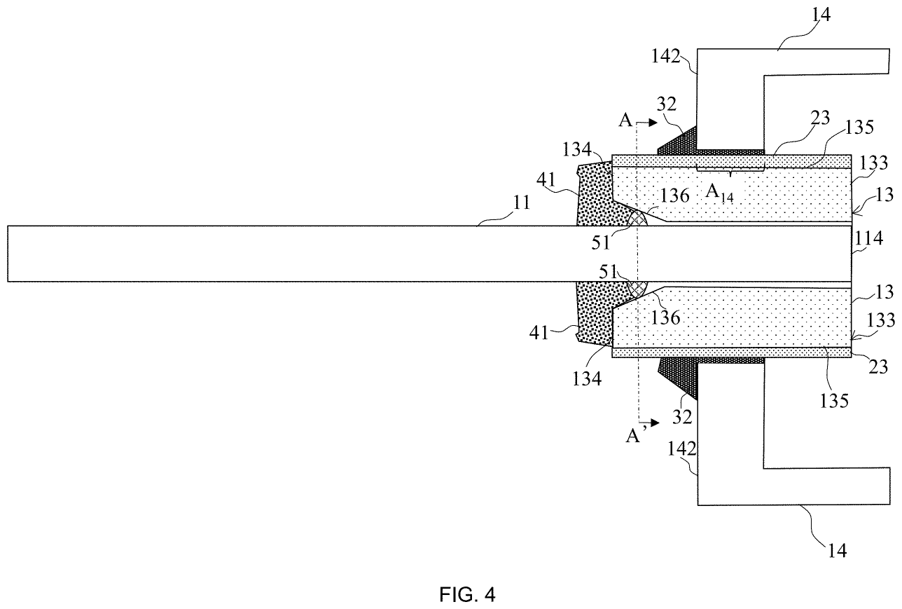

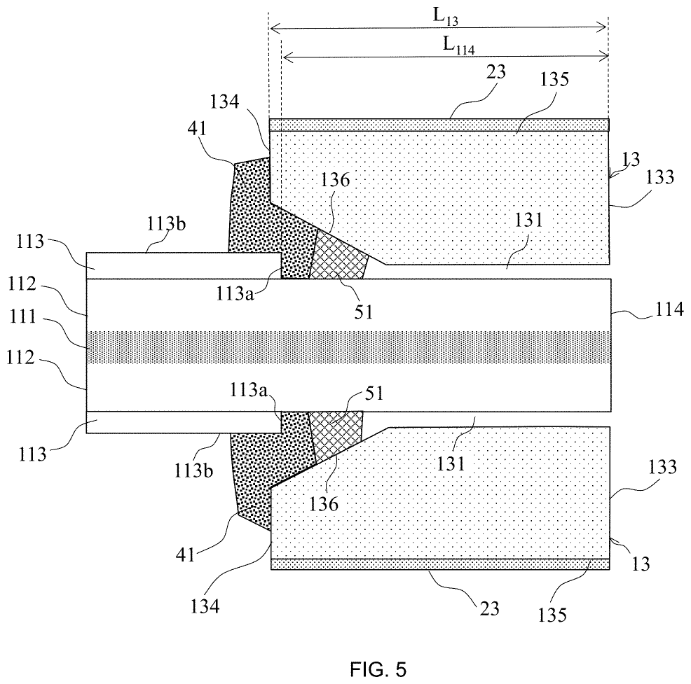

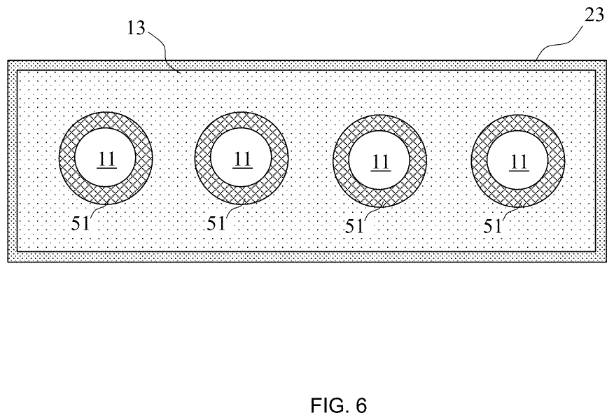

FIG. 4 illustrates exemplary mounting of the optical coupling device according to this embodiment to the casing. FIG. 5 is an enlarged view illustrating the optical coupling device according to this embodiment. FIG. 6 is a cross-sectional view taken along the line A-A′ of FIG. 4. The optical coupling device according to this embodiment includes an optical fiber 11 and a capillary 13. According to this embodiment, the optical coupling device is an optical fiber array in which a plurality of optical fibers 11 are arranged as illustrated in FIG. 6 by way of example.

A glass material may also maintain air tightness. The optical fiber 11 and the capillary 13 are formed of glass. In this regard, in the optical coupling device according to this embodiment, a gap between the optical fiber 11 and the capillary 13 is sealed with a glass material.

Similar to the first embodiment, an end portion of the optical fiber 11 is a bare fiber where a coating 113 has been removed. The capillary 13 has a through-hole for positioning the optical fiber 11 with a narrow gap. The entire bare fiber of the optical fiber 11 is positioned in the through-hole with a narrow gap. An end face 114 of the bare fiber is placed in one end arranged in the end face 133 side of the through-hole. Note that the fiber 11 can be positioned by narrowing the gap 131 between an outer diameter of the optical fiber 11 where coating has been removed and the hole of the capillary.

According to this embodiment, the gap between the bare fiber and the inner wall surface 136 inside the through-hole of the capillary 13 is sealed with low melting-point glass 51. The low melting-point glass 51 is glass having a melting point lower than those of the bare fiber and the capillary 13 of the optical fiber 11, and examples of such glass may include lead glass, phosphate-based glass, telluride-based glass, vanadate-based glass, phosphate-based glass, fluoride-based glass, soda glass, lime glass, chalcogenide glass, or the like.

Similar to the first embodiment, the end portion of the end face 134 side of the through-hole is preferably filled with the adhesive 41. In addition, similar to the first embodiment, metal plating 23 is preferably applied to the side face 135 of the capillary 13.

An end portion 113a of the coating 113 is preferably arranged inside the through-hole of the capillary 13. In addition, when the coating 113 is placed inside the through-hole of the capillary 13, the end face 134 side of the through-hole is preferably tapered. However, according to this embodiment, the metal plating 21 of the coating 113 is not necessary.

A method of producing the optical coupling device according to this embodiment includes a metal plating process, an assembling process, a melting process, a polishing process, and a bonding process in this order. The polishing process, the assembling process, and the bonding process are similar to those of the first embodiment.

In the metal plating process, metal plating is applied to the side face 135. The type of the metal plating and the plating method applied to the side face 135 are similar to those of the first embodiment.

In the melting process, a gap between the capillary 13 and the bare fiber of the optical fiber 11 placed inside the through-hole of the capillary 13 is sealed with low melting-point glass 51. For example, beads of low melting-point glass are spread in the gap between the optical fiber 11 and the capillary 13, and the beads of low melting-point glass are heated and melted at a temperature lower than the melting points of the optical fiber 11 and the capillary 13.

Here, the low melting-point glass 51 preferably has a softening point lower than those of the optical fiber 11 and the capillary 13. As a result, it is possible to seal the gap between the bare fiber and the capillary 13 with the low melting-point glass 51 while deformation of the bare fiber and the capillary 13 is prevented when the gap between the bare fiber inside the through-hole of the capillary 13 and the inner wall surface 136 is sealed with the low melting-point glass 51. In addition, the softening point of the low melting-point glass 51 is higher than a heating temperature for the soldering. As a result, it is possible to prevent the low melting-point glass 51 from being softened by the heat when the capillary 13 and the casing 14 are heated for soldering.

The low melting-point glass 51 preferably contains at least any one of a network forming component or a network modifier in order to satisfy the aforementioned softening point. The network forming component forms a network structure of the low melting-point glass and functions to determine a basic softening point. An element that functions as the network forming component of the low melting-point glass 51 may include Pb, Bi, B, Zn, V, Te, Ag, P, Sn, Ge, As, Ba, Na, K, or F. A compound that functions as the network forming component of the low melting-point glass 51 may include PbO, Bi₂O₃, B₂O₃, ZnO, V₂O₅, TeO₂, AgO₂, Ag₂O, P₂O₅, SnO, AgO, GeO₂, AsO₃, As₂O₃, BaF₂, NaF, KF, or PbF₂. For example, an example of the low melting-point glass 51 according to this disclosure is low melting-point glass containing PbO, Bi₂O₃, or B₂O₃ and having a glass transition point of 215° C. and a thermal expansion coefficient of 8×10⁻⁶/° C.

The network modifier has a function of lowering the softening point by weakening the network structure of the low melting-point glass. In addition, the network modifier also has a function of adjusting a thermal expansion coefficient. An element functioning as a network modifier of the low melting-point glass 51 may include W, F, Ag, Bi, Pb, Zn, Sn, B, Mo, Li, Ba, Te, Ta, Na, P, Fe, Cu, Cs, Sb, As, Cd, Sr, Ca, Mg, Al, K, La, Gd, Ce, V, Ge, Tl, S, Se, or Mn. A compound functioning as the network modifier of the low melting-point glass 51 may include WO₃, silver oxide, Bi₂O₃, PbO, ZnO, SnO, B₂O₃, MoO₃, Li₂O, BaO, TeO₂, Ta₂O₅, Na₂O, P₂O₅, Fe₂O₃, CuO, Cs₂O, Sb₂O₃, As₂O₃, CdO, SrO, CaO, MgO, Al₂O₃, K₂O, La₂O₃, Gd₂O₃, Ce₂O, V₂O₃, Tl₂O, MgF₂, AlF₃, ZnF₂, GeS₂, Tl₂S, or MnO.

The low melting-point glass 51 preferably has a thermal expansion coefficient smaller than that of the capillary 13 and larger than that of the bare fiber. After the gap between the bare fiber inside the through-hole of the capillary 13 and the inner wall surface 136 is sealed with the low melting-point glass 51, the capillary 13 shrinks to compress the low melting-point glass 51, and the low melting-point glass 51 shrinks to compress the bare fiber. As a result, it is possible to strengthen the coupling between the capillary 13 and the bare fiber, improve the air tightness of the optical coupling device, and prevent breakage of the optical fiber. For example, in a case where the capillary 13 (zirconia) has a thermal expansion coefficient of 10×10⁻⁶/° C., and the optical fiber (quartz) has a thermal expansion coefficient of 0.5×10⁻⁶/° C., the beads of the low melting-point glass has a thermal expansion coefficient larger than 0.5×10⁻⁶/° C. and smaller than 10×10⁻⁶/° C.

As the adjustment of the thermal expansion coefficient of the low melting-point glass 51, adjustment using a particle filling component or a negative expansion coefficient component is effective. The low melting-point glass 51 preferably contains at least any one of the particle filling component or the negative expansion coefficient component in order to satisfy the thermal expansion coefficient described above. The particle filling component has a function of changing the thermal expansion coefficient of the low melting-point glass. The element that functions as the particle filling component of the low melting-point glass 51 may include Si, Ti, P, As, Sb, V, Nb, Ta, W, Zr, or the like. The compound for adjusting the thermal expansion coefficient of the low melting-point glass 51 may include heat resistant silicate, heat resistant titanate, heat resistant ceramics formed of a V-group metal oxide (such as P, As, Sb, V, Nb, or Ta), zirconium tungstate, zirconium phosphate, beta-eucryptite, zirconium silicate, cordierite, spodumene, lead titanate, or the like.

The negative expansion coefficient component has a function of changing the thermal expansion coefficient of the low melting-point glass. An element functioning as a negative expansion coefficient component of the low melting-point glass 51 may include W, or Zr. A compound functioning as a negative expansion coefficient component of the low melting-point glass 51 may include zirconium tungstate or zirconium phosphate. When materials of both the optical fiber 11 and the capillary 13 are silica-based materials, the thermal expansion coefficients are substantially equal as small values. By using the low melting-point glass having a thermal expansion coefficient adjusted to be equal to that of quartz by the negative thermal expansion coefficient, it is possible to suppress a distortion generated by a difference of the thermal expansion coefficient.

As described above, in the optical coupling device according to this embodiment, since the gap between the optical fiber 11 and the capillary 13 is sealed with a glass material, it is possible to improve air tightness of the optical coupling device. In addition, in the optical coupling device according to this embodiment, since the end portion of the optical fiber 11 is protected by the capillary 13, it is possible to prevent breakage of the optical fiber 11. Therefore, the optical coupling device according to this embodiment is an optical coupling device for connecting the optical fiber 11 and the optical component, capable of improving air tightness and preventing breakage of the optical fiber.

Although an optical fiber array having four optical fibers 11 arranged along a straight line has been described as an example of the optical coupling device in this embodiment, the optical coupling device according to this disclosure is not limited thereto. For example, the optical coupling device according to this disclosure may have any number of optical fibers 11 such as one, 16, or 32. In addition, the optical coupling device according to this disclosure may be an optical fiber array in which the optical fibers 11 are arranged two-dimensionally.

Note that the optical fiber 11 may be formed of a plastic material. In this case, in the metal plating process, plating is applied by ion plating, electroless plating, or sputtering as in the first embodiment. In addition, a melting point of the beads of the low melting-point glass used in the melting process is set to be low so as not to affect the plastic.

### Third Embodiment

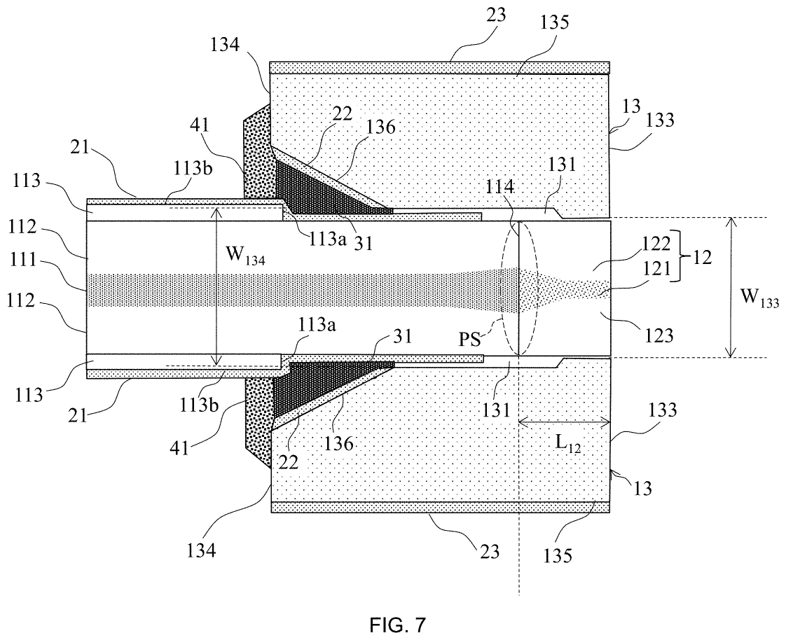

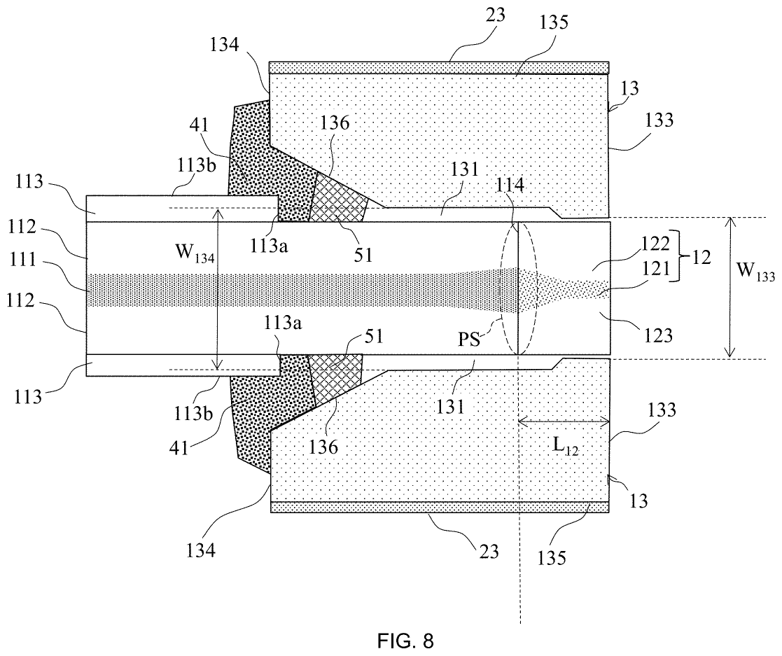

FIG. 7 illustrates a first exemplary configuration of an optical coupling device according to this embodiment. FIG. 8 illustrates a second exemplary configuration of the optical coupling device according to this embodiment. The optical coupling device of FIG. 7 has a high NA fiber 12 in an end portion as the optical fiber 11 of the first embodiment. The optical coupling device of FIG. 8 has a high NA fiber 12 in an end portion as the optical fiber 11 of the second embodiment.

The high NA fiber 12 has a numerical aperture (NA) higher than that of the optical fiber 11. For example, if the NA of the optical fiber 11 is 0.13, the NA of the high NA fiber 12 is set to an arbitrary value of 0.41 to 0.72. The end portion 123 of the high NA fiber 12 is connected to an optical circuit. By interposing the high NA fiber 12 between the optical fiber 11 and the optical circuit, it is possible to couple the light from the optical fiber 11 to the optical circuit with low loss. It is preferable that the end portion 123 of the high NA fiber 12 has been subjected to 8° polishing or anti-reflection coating in order to avoid reflection on the end portion 123.

An impurity of the high NA fiber 12 includes at least one element selected from a group consisting of Ge, Ti, and Zr. Since a refractive index increases just by adding a small amount of Ti or Zr, it is possible to further reduce the mode field diameter by adding any one of Ti or Zr. In addition, while any combination may be allowable as the mode field diameters of the optical fiber 11 and the high NA fiber 12, the mode field diameter of the high NA fiber 12 preferably substantially matches the mode field diameter of the optical circuit. For example, in a case where a single mode fiber having a mode field diameter of 10 μm is employed, and the optical circuit has a mode field diameter of 3.2 μm, a high NA single mode fiber having a mode field diameter of 3.2 μm may be employed as the high NA fiber 12.

The end face 114 of the bare fiber and one end face of the high NA fiber 12 are fusion-bonded with a fusion bonded portion PS. By performing the fusion bonding, the impurity added to the core is diffused due to local heating, so that the core expands in a bell-shaped distribution. For this reason, it is possible to connect the optical fiber 11 and the high NA fiber 12, that is, different types of fibers, with little loss and widen an allowable decentering range.

The capillary 13 has a through-hole, and the fusion bonded portion PS is placed inside the through-hole, and the end portion of the high NA optical fiber 12 is positioned in a narrow gap in one end of the through-hole. A gap 131 between the inner wall surface of the through-hole and the fusion bonded portion PS is preferably filled with an adhesive. As a result, it is possible to protect the fusion bonded portion PS using the capillary 13.

An inner diameter W₁₃₃ around the end portion 123 of the high NA fiber 12 preferably substantially matches a cladding diameter of the high NA fiber 12. For example, if the high NA fiber 12 has a cladding diameter of 125 μm, the inner diameter W₁₃₃ is set to “126 μm≤W₁₃₃≤127 μm”.

An inner diameter W₁₃₄ of the fusion bonded portion PS is larger than the inner diameter W₁₃₃ around the end portion 123 of the high NA fiber 12. This is because the cladding diameter increases in the fusion bonded portion. For example, if the high NA fiber 12 has a length L₁₂ and the high NA fiber 12 has a cladding diameter of 125 μm, the inner diameter W₁₃₄ at a distance L₁₂ from the end face 133 is preferably set to “127 μm<W₁₃₄≤152 μm”.

Note that the optical fiber 11 and the high NA fiber 12 may be formed of plastic. In this case, bonding for connecting the optical fiber 11 and the high NA fiber 12 is performed using any adhesive instead of the fusion bonding. In addition, the high NA fiber 12 may be a planar light wave circuit (PLC) chip.

### INDUSTRIAL APPLICABILITY

This disclosure is applicable to an information communication technology industry.

### REFERENCE SIGNS LIST

11 OPTICAL FIBER

111 CORE

112 CLADDING

113 COATING

114 END FACE OF BARE FIBER

12 HIGH NA FIBER

121 CORE

122 CLADDING

123 END PORTION OF HIGH NA FIBER

13 CAPILLARY

131 GAP

133, 134 END FACE

135 SIDE FACE

136 INNER WALL

14 CASING

21, 22, 23 METAL PLATING

31, 32 SOLDER

41 ADHESIVE

51 LOW MELTING-POINT GLASS

1. An optical coupling device comprising:
an optical fiber having an end portion being a bare fiber where a part of coating has been removed, metal plating being applied to the bare fiber around an end portion of the remaining coating and a circumference of the coating;
a capillary having a through-hole having one end where the end portion of the bare fiber is positioned and an other end where the end portion of the coating of the optical fiber subjected to the metal plating is placed, metal plating being applied to an inner wall surface of the other end of the through-hole; and
solder that seals a gap between the optical fiber placed in the other end of the through-hole and an inner wall of the through-hole.

2. An optical coupling device comprising:
an optical fiber having an end portion being a bare fiber where a part of coating has been removed;
a capillary having a through-hole having one end where the end portion of the bare fiber is positioned and the other end where an end portion of the remaining coating of the optical fiber is placed; and
low melting-point glass that seals a gap between the bare fiber placed inside the through-hole and an inner wall of the through-hole, the low melting-point glass having a melting point lower than those of the bare fiber and the capillary.

3. The optical coupling device according to claim 1, wherein the other end of the through-hole of the capillary is tapered.

4. The optical coupling device according to claim 1, wherein the end portion of the bare fiber is positioned in the one end of the through-hole with a gap narrower than that of the other end of the through-hole.

5. The optical coupling device according to claim 1, wherein
the optical fiber includes a first optical fiber and a second optical fiber, the second optical fiber having a core having a numerical aperture larger than that of the first optical fiber and having one end fusion-bonded to the first optical fiber,
fusion bonded portions of the first and second optical fibers are placed inside the through-hole,
an end portion of the second optical fiber is positioned in the one end of the through-hole with a gap narrower than that of the other end of the through-hole, and
the fusion bonded portion of the through-hole has an inner diameter larger than that of a vicinity of an other end portion of the second optical fiber.

6. The optical coupling device according to claim 1, wherein metal plating is applied to a side face of the capillary.

7. The optical coupling device according to claim 2, wherein the other end of the through-hole of the capillary is tapered.

8. The optical coupling device according to claim 2, wherein the end portion of the bare fiber is positioned in the one end of the through-hole with a gap narrower than that of the other end of the through-hole.

9. The optical coupling device according to claim 2, wherein
the optical fiber includes a first optical fiber and a second optical fiber, the second optical fiber having a core having a numerical aperture larger than that of the first optical fiber and having one end fusion-bonded to the first optical fiber,
fusion bonded portions of the first and second optical fibers are placed inside the through-hole,
an end portion of the second optical fiber is positioned in the one end of the through-hole with a gap narrower than that of the other end of the through-hole, and
the fusion bonded portion of the through-hole has an inner diameter larger than that of a vicinity of an other end portion of the second optical fiber.

10. The optical coupling device according to claim 2, wherein metal plating is applied to a side face of the capillary.
